(19) United States
(12) Patent Application Publication
(10) Pub. No.: US 2006/0263087 A1
(43) Pub. Date: Nov. 23, 2006

(54) Method and system for using a time to live field in a fibre channel switch element

(76) Inventors: Frank R. Dropps, Maple Grove, MN (US); Edward C. McGlaughlin, Minneapolis, MN (US); Craig W. Carlson, Minneapolis, MN (US)

Correspondence Address: KLEIN, O'NEILL & SINGH, LLP, 43 CORPORATE PARK, SUITE 204, IRVINE, CA, 92606, US

(21) Appl. No.: 11/134,888

(22) Filed: May 23, 2005

(51) Int. Cl. H04J 14/00

(52) U.S. Cl. 398/51

(57) ABSTRACT

Method and system for processing frames in a fibre channel network is provided. The method includes, determining if an incoming frame in a port of a fibre channel switch includes a FR_Header with a time to live time (“TTLT”) field value; determining if the TTLT field value is greater than a certain number; adjusting the TTLT field value at a pre-determined time interval if the TTLT field value is greater than the certain number; and inserting an adjusted TTLT field value in the incoming frame before it is sent out. The switch element includes, a port that receives an incoming frame and determines if a FR_Header with a time to live time (“TTLT”) field value is received with the FR_Header, and using a timer adjusts the TTLT field value and inserts the adjusted TTLT field value in the incoming frame, before it is sent out.

### BACKGROUND

1. Field of the Invention

The present invention relates to Fibre Channel networks, and more particularly, to using a time to live field in a Fibre Channel switch.

2. Background of the Invention

Fibre Channel is a set of American National Standard Institute (ANSI) standards, which provide a serial transmission protocol for storage and network protocols such as HIPPI, SCSI, IP, ATM and others. Fibre Channel provides an input/output interface to meet the requirements of both channel and network users.

Fibre Channel supports three different topologies: point-to-point, arbitrated loop and Fibre Channel fabric. The point-to-point topology attaches two devices directly. The arbitrated loop topology attaches devices in a loop. The Fibre Channel fabric topology attaches host systems directly to a fabric, which are then connected to multiple devices. The Fibre Channel fabric topology allows several media types to be interconnected.

Fibre Channel fabric devices include a node port or “N_Port” that manages fabric connections. The N_port establishes a connection to a fabric element (e.g., a switch) having a fabric port or “F_port”.

A Fibre Channel switch is a multi-port device where each port manages a point-to-point connection between itself and its attached system. Each port can be attached to a server, peripheral, I/O subsystem, bridge, hub, router, or even another switch. A switch receives messages from one port and routes it to another port.

Fibre Channel switches use memory buffers to hold frames received and sent across a network. Associated with these buffers are credits, which are the number of frames that a buffer can hold per fabric port.

Fibre Channel standards are now being extended for use with expanded Fabrics. Fibre Channel proposal, T11/04-520v1 (proposed for standardization in ANSI/INCITS Project Number 1745-D(FC-IFR)), incorporated herein by reference in its entirety, describes multiple Fabrics and how they should be interconnected. FIG. 1F shows a block diagram of a system having multiple fabrics. Fabrics A,B,C,D,E and F are individual Fabrics. Host I1 attached to Fabric A uses Fabric Routers 1, 2 3, or 4 to communicate with devices T2 and T3. A Fabric Router is a Fibre Channel device that allows Fibre Channel devices, via N_Ports, to be shared among multiple independent Fibre Channel fabrics.

A proposed Fibre Channel Inter-Fabric routing header (FR_Header) provides for a “time out” field based on which frames will be “timed out” (i.e. expired) and then discarded. FIG. 1E shows an example of the proposed FR_Header format. This header is recognized when the R_CTL value in a frame is equal to hex 51. The proposed field is shown as “Exp_time” 107. Field 107 is used to time out and discard a frame.

The proposed standard field (107) and methodology has disadvantages. FIG. 1G shows a block diagram to illustrate the shortcomings of the Exp_Time value 107. FIG. 1G shows Switch 1 in Fabric 1, Switch 2 in fabric 2 and Switch 3 in Fabric 3. Switch 1 receives a frame with the Exp_time value 107. Switch 1 sends the frame to Switch 2. To determine if the frame has expired or not (based on the Exp_Time value), Switch 2 clock domain should be synchronized with the Switch 1 clock domain. Same thing applies when the frame reaches Switch 3. Synchronizing plural clocks for Inter-Fabric frame traffic is very difficult to achieve, especially in large networks.

Therefore, there is a need for a method and system for efficiently discarding frames in Fibre Channel networks.

### SUMMARY OF THE PRESENT INVENTION

In one aspect of the present invention, a method for processing frames in a fibre channel network is provided. The method includes, determining if an incoming frame in a port of a fibre channel switch element includes a FR_Header with a time to live time (“TTLT”) field value; determining if the TTLT field value is greater than a certain number; adjusting the TTLT field value at a pre-determined time interval if the TTLT field value is greater than the certain number; and inserting an adjusted TTLT field value in the incoming frame before it is sent out to another port, wherein the adjusted TTLT field value is based on a difference between the TTLT field value and a duration that the incoming frame spends in the port.

In another aspect of the present invention, a fibre channel switch element is provided. The switch element includes, a port that receives an incoming frame and determines if a FR_Header with a time to live time (“TTLT”) field value is received with the FR_Header, and using a timer adjusts the TTLT field value and inserts the adjusted TTLT field value in the incoming frame, before it is sent out. The TTLT field value in the incoming frame is decreased after a certain period, if the TTLT field value in the incoming frame is greater than zero. If the TTLT field value is equal to or less than zero, the incoming frame is considered expired.

This brief summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows an example of a Fibre Channel system;

FIG. 1B shows an example of a Fibre Channel switch element, according to one aspect of the present invention;

FIG. 1C shows a block diagram of a 20-channel switch chassis, according to one aspect of the present invention;

FIG. 1D shows a block diagram of a Fibre Channel switch element with sixteen GL_Ports and four 10G ports, according to one aspect of the present invention;

FIG. 1E shows an example of a FR-Header format, according to one aspect of the present invention;

FIG. 1F shows a block diagram of a system with multiple fabrics that can use the time to live field, according to one aspect of the present invention;

FIG. 1G illustrate the disadvantages of using a Exp_Time value in the FR-Header;

FIG. 2 shows a block diagram of a switch element for using a timer field, according to one aspect of the present invention;

FIG. 3 shows a process flow diagram for processing frames, according to one aspect of the present invention; and

FIG. 4 shows a block diagram to illustrate the advantage of using a time to live field in a FR_Header, according to one aspect of the present invention.

### DETAILED DESCRIPTION OF THE PREFERRED EMBODIMENTS

Definitions:

The following definitions are provided as they are typically (but not exclusively) used in the Fibre Channel environment, implementing the various adaptive aspects of the present invention.

“D_ID”: A 24-bit Fibre Channel header field that contains the destination address for a frame.

“E_Port”: A fabric expansion port that attaches to another Interconnect port to create an Inter-Switch Link.

“F_Port”: A port to which non-loop N_Ports are attached to a fabric and does not include FL_ports.

“Fibre Channel ANSI Standard” (“FC-FS”): The standard (incorporated herein by reference in its entirety) describes the physical interface, transmission and signaling protocol of a high performance serial link for support of other high level protocols associated with IPI, SCSI, IP, ATM and others.

“Fabric”: The structure or organization of a group of switches, target and host devices (NL_Port, N_ports etc.).

“Fabric Identifier” (may also be referred to as “Fabric ID”): An identifier that is used to identify a Fabric for a Fabric Router function.

“Fabric Router”: A Fibre Channel device that allows Fibre Channel Devices, via N_Ports to be shared among multiple independent Fibre Channel Fabrics.

“Fabric Topology”: This is a topology where a device is directly attached to a Fibre Channel Fabric that uses destination identifiers embedded in frame headers to route frames through a Fibre Channel fabric to a desired destination.

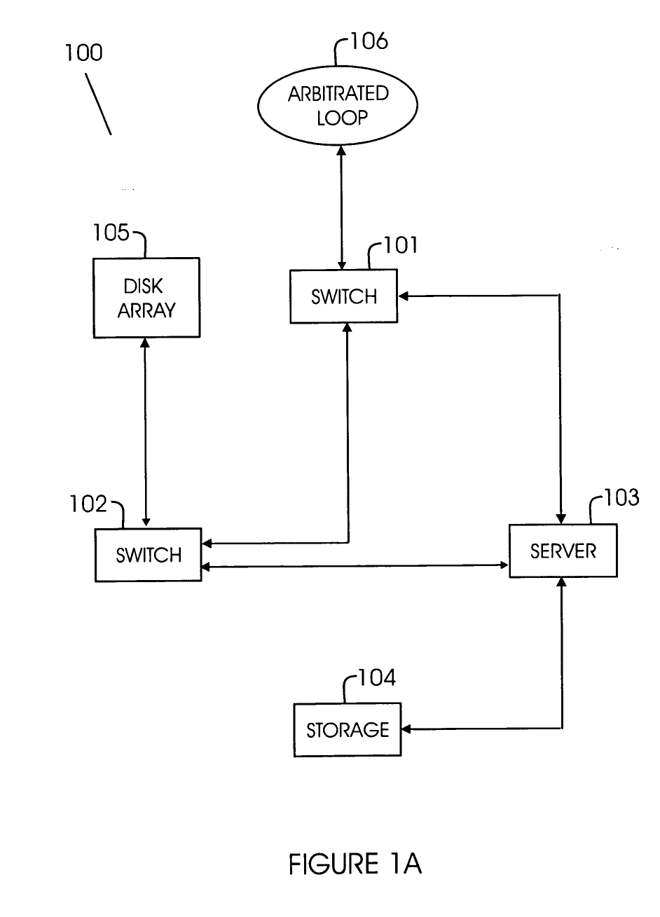

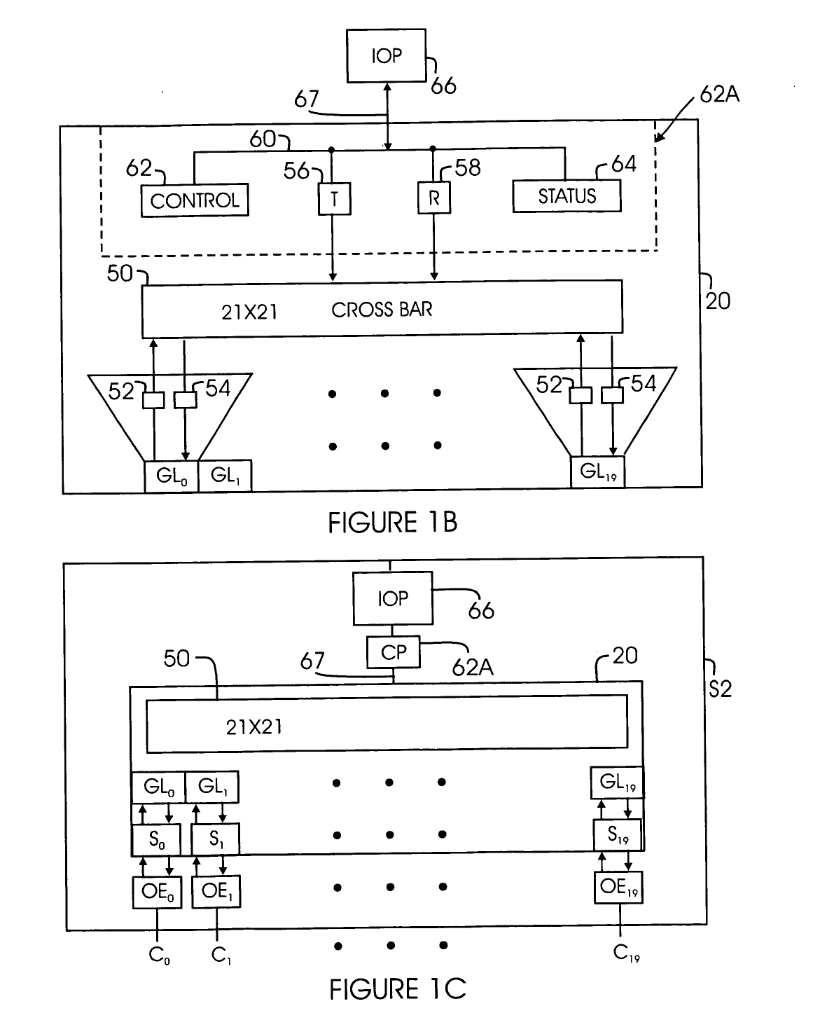

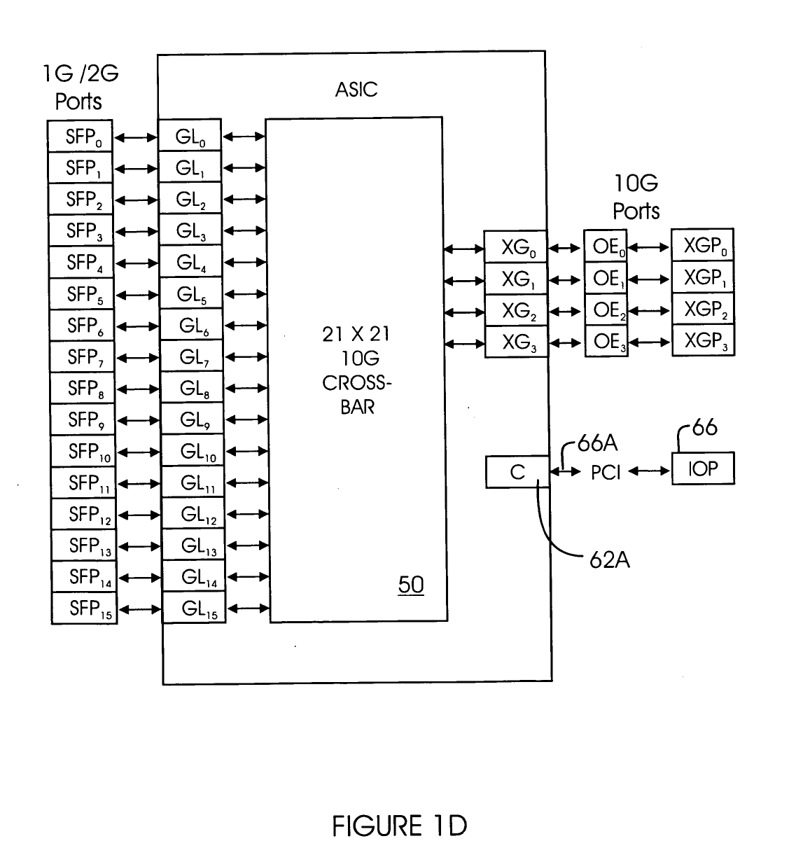

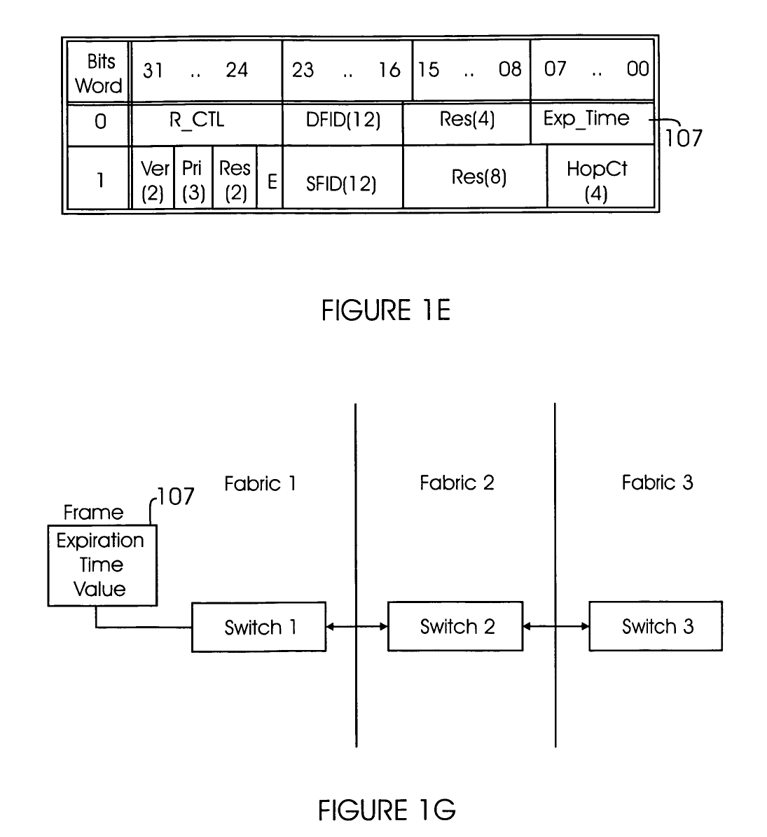

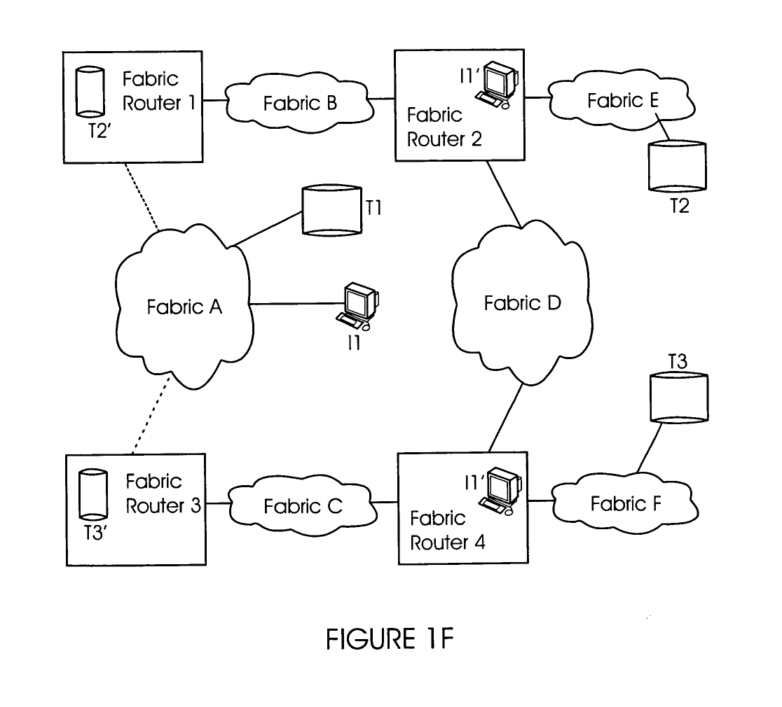

“FR_Header”: A header format (shown in FIG. 1E) defined by T11/04-520v0 for a Fabric Router for routing frames between different Fabrics.

“N_Port”: A direct fabric attached port, for example, a disk drive or a HBA.

“NL_Port”: A L_Port that can perform the function of a N_Port.

“Port”: A general reference to N. Sub.—Port or F.Sub.—Port.

“SAN”: Storage Area Network

“S_ID”: A 24-bit field in a Fibre Channel frame header that contains the source address for a frame.

“Switch”: A fabric element conforming to the Fibre Channel Switch standards.

In one aspect of the present invention, a new field for the FR_Header is provided instead of the Exp_Time field 107. This new field is referred to herein as the “Time to Live Time Field” (“TTLT”). The TTLT field is set to a maximum amount of time that a frame can exist while the frame is in transit from a source to its destination. The field may be set by an ingress routing function that is described in T11 standard 04-520v1. The maximum time may be any value that is decided by the Fibre Channel standard or can be based on network demands/congestion. The TTLT field is used to monitor the elapsed time in a local switch and hence does not require synchronization of time between plural Fabric elements.

Each Fabric switch element that receives a frame with a FR_Header checks the TTLT field value. If the field is already zero then the frame is ignored. If the field has a certain value, then the time value is reduced by a certain amount. If the field value reaches a certain predefined value, for example, 0, then the frame is discarded. This signifies that the frame has out-lived its life. If the TTLT has not reached a certain value, for example, 0, then the field value is reduced and the frame is transmitted.

To facilitate an understanding of the preferred embodiment, the general architecture and operation of a Fibre channel System and a Fibre Channel switch element will be described. The specific architecture and operation of the preferred embodiment will then be described with reference to the general architecture.

Fibre Channel System:

FIG. 1A is a block diagram of a fibre channel system 100 implementing the methods and systems in accordance with the adaptive aspects of the present invention. System 100 includes plural devices that are interconnected. Each device includes one or more ports, classified as node ports (N_Ports), fabric ports (F_Ports), and expansion ports (E_Ports). Node ports may be located in a node device, e.g. server 103, disk array 105 and storage device 104. Fabric ports are located in fabric devices such as switch 101 and 102. Arbitrated loop 106 may be operationally coupled to switch 101 using arbitrated loop ports (FL_Ports).

The devices of FIG. 1A are operationally coupled via “links” or “paths”. A path may be established between two N_ports, e.g. between server 103 and storage 104. A packet-switched path may be established using multiple links, e.g. an N-Port in server 103 may establish a path with disk array 105 through switch 102.

Fibre Channel Switch Element:

FIG. 1B is a block diagram of a 20-port ASIC fabric element according to one aspect of the present invention. FIG. 1B provides the general architecture of a 20-channel switch chassis using the 20-port fabric element. Fabric element includes ASIC 20 with non-blocking Fibre Channel class 2 (connectionless, acknowledged) and class 3 (connectionless, unacknowledged) service between any ports. It is noteworthy that ASIC 20 may also be designed for class 1 (connection-oriented) service, within the scope and operation of the present invention as described herein.

The fabric element of the present invention is presently implemented as a single CMOS ASIC, and for this reason the term “fabric element” and ASIC are used interchangeably to refer to the preferred embodiments in this specification. Although FIG. 1B shows 20 ports, the present invention is not limited to any particular number of ports.

ASIC 20 has 20 ports numbered in FIG. 1B as GL0 through GL19. These ports are generic to common Fibre Channel port types, for example, F_Port, FL_Port and E-Port. In other words, depending upon what it is attached to, each GL port can function as any type of port. Also, the GL port may function as a special port useful in fabric element linking, as described below.

For illustration purposes only, all GL ports are drawn on the same side of ASIC 20 in FIG. 1B. However, the ports may be located on both sides of ASIC 20 as shown in other figures. This does not imply any difference in port or ASIC design. Actual physical layout of the ports will depend on the physical layout of the ASIC.

Each port GL0-GL19 has transmit and receive connections to switch crossbar 50. One connection is through receive buffer 52, which functions to receive and temporarily hold a frame during a routing operation. The other connection is through a transmit buffer 54.

Switch crossbar 50 includes a number of switch crossbars for handling specific types of data and data flow control information. For illustration purposes only, switch crossbar 50 is shown as a single crossbar. Switch crossbar 50 is a connectionless crossbar (packet switch) of known conventional design, sized to connect 21×21 paths. This is to accommodate 20 GL ports plus a port for connection to a fabric controller, which may be external to ASIC 20.

In the preferred embodiments of switch chassis described herein, the fabric controller is a firmware-programmed microprocessor, also referred to as the input/output processor (“IOP”). IOP 66 is shown in FIG. 1C as a part of a switch chassis utilizing one or more of ASIC 20. As seen in FIG. 1B, bi-directional connection to IOP 66 is routed through port 67, which connects internally to a control bus 60. Transmit buffer 56, receive buffer 58, control register 62 and Status register 64 connect to bus 60. Transmit buffer 56 and receive buffer 58 connect the internal connectionless switch crossbar 50 to IOP 66 so that it can source or sink frames.

Control register 62 receives and holds control information from IOP 66, so that IOP 66 can change characteristics or operating configuration of ASIC 20 by placing certain control words in register 62. IOP 66 can read status of ASIC 20 by monitoring various codes that are placed in status register 64 by monitoring circuits (not shown).

FIG. 1C shows a 20-channel switch chassis S2 using ASIC 20 and IOP 66. S2 will also include other elements, for example, a power supply (not shown). The 20 GL_Ports correspond to channel C0-C19. Each GL_Port has a serial/deserializer (SERDES) designated as S0-S19. Ideally, the SERDES functions are implemented on ASIC 20 for efficiency, but may alternatively be external to each GL_Port. The SERDES converts parallel data into a serial data stream for transmission and converts received serial data into parallel data. The 8 bit to 10 bit encoding enables the SERDES to generate a clock signal from the received data stream.

Each GL_Port may have an optical-electric converter, designated as OE0-OE19 connected with its SERDES through serial lines, for providing fibre optic input/output connections, as is well known in the high performance switch design. The converters connect to switch channels C0-C19. It is noteworthy that the ports can connect through copper paths or other means instead of optical-electric converters.

FIG. 1D shows a block diagram of ASIC 20 with sixteen GL ports and four 10G (Gigabyte) port control modules designated as XG0-XG3 for four 10G ports designated as XGP0-XGP3. ASIC 20 include a control port 62A that is coupled to IOP 66 through a PCI connection 66A.

TTLT Field Value Usage:

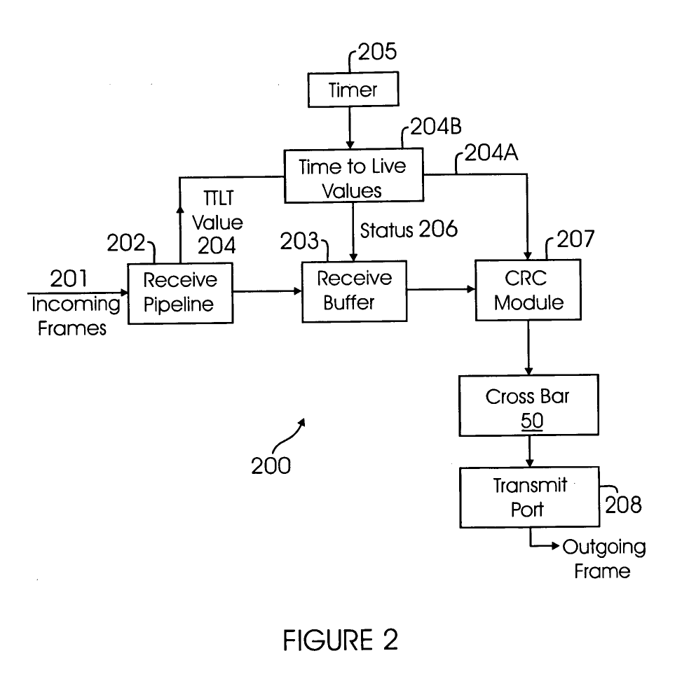

FIG. 2 shows an example of a receive port 200, according to one aspect of the present invention. Port 200 includes a receive pipeline 202 that receives incoming frames/Fibre Channel frames/data 201. Incoming frames are processed and moved to a transmit port 208 via crossbar 50. The transmit port 208 transmits the data to its intended destination. Details of the pipelines and how frames are transmitted are provided in the patent application Ser. No. 10/894,596, filed on Jul. 20, 2004, the disclosure of which is incorporated herein by reference in its entirety.

When an incoming frame 201 is received by receive port 200, the receive pipeline determines if the frame has an FR_Header with a TTLT field set. If the frame has a FR-Header with a set TTLT field, then the TTLT field value 204 is stored in storage 204B (shown as “time to live values” in FIG. 2) and a timer 205 starts decrementing the TTLT field value 204 for the time that the frame spends in the receive port 200.

Timer 205 can be programmed by switch firmware to decrement after a certain period, for example, after 100 milliseconds or any other value. If the TTLT field value reaches a certain value, for example, 0, then a status 206 is sent to receive buffer 203 and the frame is timed out. The response and how a timed out frame should be disposed can be determined by switch firmware/software, as described below.

If the TTLT value 204 does not become zero and the frame is to be sent to the transmit port 208, then an updated (adjusted or decreased) TTLT field value 204A is sent to a cyclic redundancy check (“CRC”) module 207 that calculates a new CRC for the outgoing frame. CRC values are calculated using standard techniques to determine frame errors.

The adjusted TTLT value 204A is merged in the outgoing frame. The frame with the updated TTLT and updated CRC value is then sent to the transmit port 208.

If the CRC value for the incoming frame 201 was bad when it was received, then the frame is tagged by changing the End of Frame (“EOF”) code to indicate a bad frame.

It is noteworthy that the logic shown above with respect to the receive port 200 may be used in the transmit port to adjust the TTLT field values.

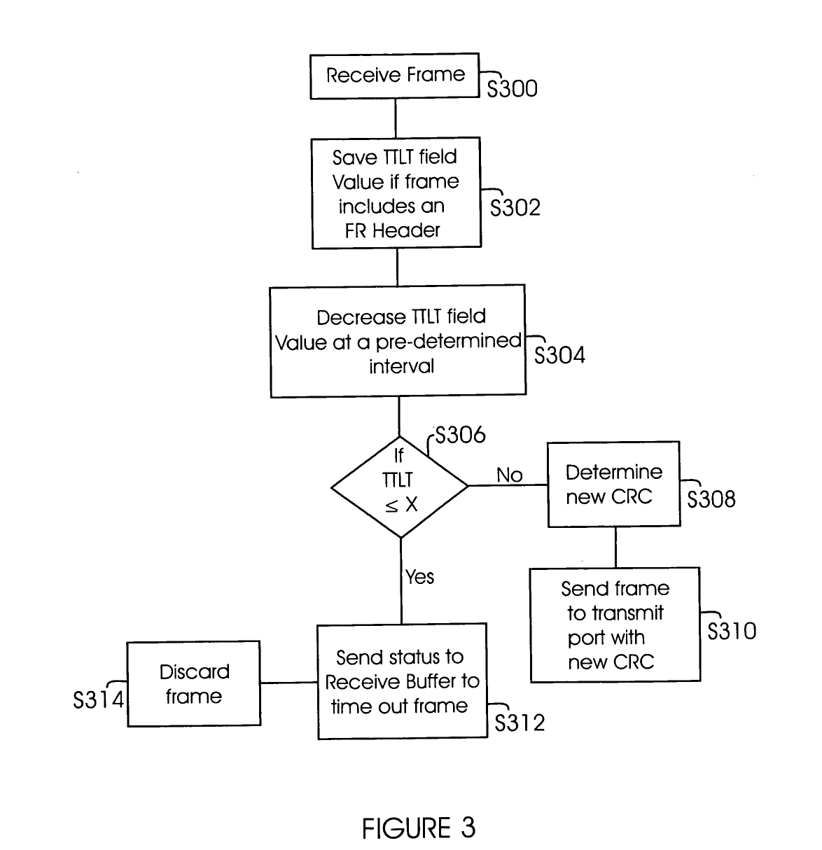

FIG. 3 shows a process flow diagram for processing frames in a Fibre Channel based network.

Incoming frames are received in step S300. The frames are stored in receive buffer 203, after passing through receive pipeline 202.

If the incoming frame has a FR_Header with a TTLT field value, then the TTLT field value 204 is stored (shown as 204B).

If the TTLT field value is not equal to zero, then in step S304, the TTLT field value 204 is adjusted (decreased or modified) at a pre-determined time interval. Timer 205 is used to decrease the TTLT value. For example, the TTLT field value can be decreased every 100 milliseconds (or any other interval) while the frame is in the receive port 200 before being sent to the transmit port 208.

The TTLT field value can also be decreased by a value that is proportional to the amount of time a frame spends on an active fibre channel link medium (or fibre or “wire”). This is especially useful where the optical fibre length is long. For example, if a frame has traveled on a fibre channel cable that is say 1 mile long, then the receive port deducts a value “t” from the TTLT field value when the frame enters the switch element. This adjusts the TTLT field value based on the time that a frame spent on the fibre itself. This decrement is in addition to the adjustment that takes place in step S304.

In step S306, the TTLT field value is compared to a certain value X, for example, zero. If TTLT field value is equal to (or less than) zero, then in step S312, a status is sent to receive buffer 203 to discard frame 201 in step S314. The frame can be tagged so that it is discarded at the transmit port.

It is noteworthy that frames can be discarded based on the class of the frame. For example, a Class 2 fibre channel frame is not discarded and instead sent to IOP 66. IOP 66 maintains a count for the timed out frames. IOP 66 (and/or other counters, not shown) saves information regarding the timed out frames for any analysis that may be performed. For example, a network administrator may want to know the source, destination or type of the timed out frames to optimize overall network performance. Also, the switch element itself (besides IOP 66) can maintain a count for the timed out (and/or discarded frames) using local switch element resources.

A class 3 frame can be discarded by one of the ports (receive and/or transmit port) based on a priority scheme that is programmed by the switch element firmware and may not be sent to IOP 66.

If the TTLT field value is greater than zero, then in step S308, a new CRC value is determined by CRC module 207. An adjusted TTLT field value 204A is inserted in the outgoing frame and the frame is sent to the transmit port with the new CRC value and a new TTLT value. The adjusted TTLT field value 204A is based on the difference between the original TTLT field value 204 and the time the frame spends in receive port 200.

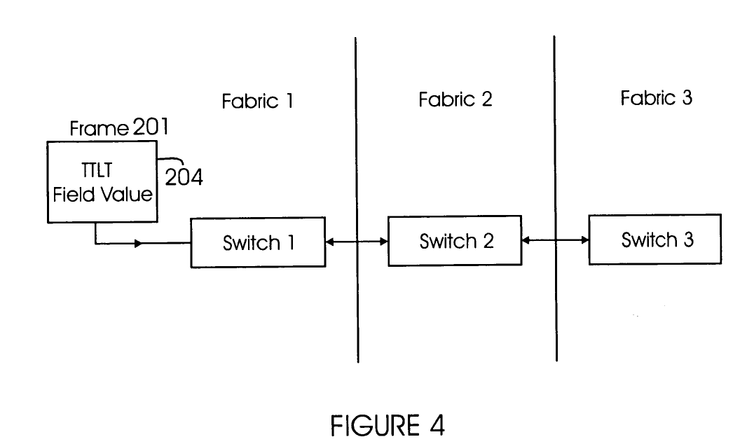

One advantage of using the TTLT field value instead of an expiration value (Exp_Time) is that switches in different Fabrics do not have to synchronize their clocks. This is illustrated in FIG. 4.

When frame 201 with TTLT value 204 enters switch 1 in Fabric 1, then the TTLT value is adjusted based on how long the frame stays in switch 1, before it is sent to switch 2. The adjustment to the TTLT value is based strictly on the local time domain of switch 1 and Fabric 1. Switch 2 in Fabric 2 and switch 3 and Fabric 3 adjust the TTLT value based on their own local time domains. No synchronization is required between the different clock domains for Fabric 1, Fabric 2 and Fabric 3, to determine when a frame should be timed out.

It is noteworthy that although the foregoing process steps have been described to occur in a receive port of a switch element, the present invention is not limited to the receive port. For example, the foregoing TTLT field modifications can take place anywhere between the receive port and the transmit port of a switch element.

Although the present invention has been described with reference to specific embodiments, these embodiments are illustrative only and not limiting. Many other applications and embodiments of the present invention will be apparent in light of this disclosure and the following claims.

What is claimed is:

1. A method for processing frames in a fibre channel network, comprising:
determining if an incoming frame in a port of a fibre channel switch element includes a FR_Header with a time to live time (“TTLT”) field value;
determining if the TTLT field value is greater than a certain number;
adjusting the TTLT field value at a pre-determined time interval if the TTLT field value is greater than the certain number; and
inserting an adjusted TTLT field value in the incoming frame before it is sent out to another port, wherein the adjusted TTLT field value is based on a difference between the TTLT field value and a duration that the incoming frame spends in the port of the fibre channel switch element.

2. The method of claim 1, wherein the certain number value is equal to zero.

3. The method of claim 2, further comprising:
determining a new cyclic redundancy check (“CRC”)value, if the TTLT field value is greater than zero.

4. The method of claim 1, wherein the incoming frame is discarded if the adjusted TTLT field value is equal to zero indicating that the incoming frame has expired.

5. The method of claim 4, wherein an expired frame is sent to a processor based on the class of the expired frame.

6. The method of claim 4, wherein a Class 2, Fibre Channel frame is sent to a processor.

7. The method of claim 4, wherein a Class 3 frame is discarded.

8. The method of claim 1, wherein a timer is used to decrease the TTLT field value at the pre-determined time interval.

9. The method of claim 1, wherein the TTLT field value is decreased by a certain value to compensate for a duration that an incoming frame spends on a fibre channel media link.

10. A method for processing frames in a fibre channel network, comprising:
determining if an incoming frame in a receive port of a fibre channel switch element includes a FR_Header with a time to live time (“TTLT”) field value;
determining if the TTLT field value is greater than zero;
decreasing the TTLT field value by a pre-determined number at a pre-determined time interval if the TTLT field value is greater than zero; and
inserting an adjusted TTLT field value in the incoming frame before it is sent to a transmit port, wherein the adjusted TTLT field value is based on a difference between the TTLT field value and a duration that the incoming frame spends in the receive port.

11. The method of claim 10, further comprising:
determining a new cyclic redundancy check (“CRC”)value, if the TTLT field value is greater than zero.

12. The method of claim 10, wherein the incoming frame is discarded if the TTLT field value is equal to zero indicating that the incoming frame has expired.

13. The method of claim 10, wherein a timer is used to decrease the TTLT field value at the pre-determined time interval.

14. A fibre channel switch element, comprising:
a port in the fibre channel switch that receives an incoming frame and determines if a FR_Header with a time to live time (“TTLT”) field value is received with the FR_Header, and using a timer adjusts the TTLT field value and inserts the adjusted TTLT field value in the incoming frame, before it is sent out to another port.

15. The fibre channel switch element of claim 14, wherein the TTLT field value in the incoming frame is decreased after a certain period, if the TTLT field value in the incoming frame is greater than zero.

16. The fibre channel switch element of claim 14, wherein if the TTLT field value is equal to or less than zero, the incoming frame is considered expired.

17. The fibre channel switch element of claim 16, wherein an expired frame is sent to a processor based on the class of the expired frame.

18. The fibre channel switch element of claim 17, wherein a Class 2, Fibre Channel frame is sent to a processor.

19. The fibre channel switch element of claim 16, wherein a Class 3 frame is discarded.

20. The fibre channel switch element of claim 14, wherein the TTLT field value is decreased by a certain value to compensate for a duration that an incoming frame spends on a fibre channel media link.

21. The fibre channel switch element of claim 14, wherein a new cyclic redundancy check (“CRC”) value is determined for the incoming frame, before the incoming frame is sent to the other port

22. The fibre channel switch element of claim 14, wherein the adjusted TTLT field value is based on a duration that the incoming frame spends in the port.
